(19) United States
(12) Patent Application Publication
(10) Pub. No.: US 2019/0049782 A1
(43) Pub. Date: Feb. 14, 2019

(54) NAKED EYE THREE-DIMENSIONAL LIQUID CRYSTAL DISPLAY PANEL AND NAKED EYE THREE-DIMENSIONAL LIQUID CRYSTAL DISPLAY DEVICE

(71) Applicant: Shenzhen China Star Optoelectronics Semiconductor Display Technology Co., LTD., Shenzhen (CN)

(72) Inventor: Linfeng LIU, Shenzhen (CN)

(21) Appl. No.: 15/569,398

(22) PCT Filed: May 3, 2017
(86) PCT No.: PCT/CN2017/082817

§ 371 Date: Oct. 26, 2017

(30) Foreign Application Priority Data
Apr. 1, 2017 (CN) 201710212897.8

(51) Int. Cl. G02F 1/1335; G02B 27/22; H04N 13/302; G02F 1/1343

(52) U.S. Cl. CPC G02F 1/133526; G02B 27/2214; H04N 13/302; G02F 2201/121; G02F 1/133512; G02F 1/133615; G02F 1/134309; G02F 1/133514

(57) ABSTRACT

A naked eye three-dimensional liquid crystal display panel is described and has a back light source, a liquid crystal display panel and a liquid crystal lens array, wherein the liquid crystal display panel has a color filter substrate, an array substrate and a display liquid crystal layer, and the liquid crystal display panel has a plurality of pixel units. The liquid crystal lens array has a first substrate, a second substrate and a lens liquid crystal layer, and the liquid crystal lens array has a plurality of lens units, wherein a black blanket structure is disposed in the lens liquid crystal layer and between the neighboring lens units.

### FIELD OF THE DISCLOSURE

The present disclosure relates to a liquid crystal display panel, and more particularly to a naked eye three-dimensional liquid crystal display panel and a naked eye three-dimensional liquid crystal display device.

### BACKGROUND OF THE DISCLOSURE

FIG. 1 is a structural schematic diagram of a conventional naked eye three-dimensional liquid crystal display panel. The naked eye three-dimensional liquid crystal display panel 10 comprises a back light source 11, a liquid crystal display panel 12, and a liquid crystal lens array 13. The liquid crystal lens array 13 is disposed on a light emitting surface of the liquid crystal display panel 12 by a transparent glue 14 and is used to switch between a three-dimensional display mode and a two-dimensional display mode of the naked eye three-dimensional liquid crystal display panel 10.

The liquid crystal display panel 12 comprises a color filter substrate 121, an array substrate 122, and a display liquid crystal layer 123 disposed between the color filter substrate 121 and the array substrate 122, and the liquid crystal display panel 123 comprises a plurality of pixel units simultaneously.

The liquid crystal lens array 13 comprises a first substrate 131, a second substrate 132, and a lens liquid crystal layer 133 disposed between the first substrate 131 and the second substrate 132, wherein a first transparent electrode 134 is disposed on the first substrate 131, and a second transparent electrode 135 is disposed on the second substrate 132. The liquid crystal lens array 13 comprises a plurality of lens units simultaneously, and each of the lens units can separately control a form of a corresponding liquid crystal in the lens liquid crystal layer, wherein each of the lens units is respectively corresponding to at least one of the pixel units. The lens liquid crystal layer 133 neighboring to the lens units is isolated by a transparent blanket 136.

Please refer to FIG. 1, when the naked eye three-dimensional liquid crystal display panel 10 is used, a parallel light emitted by the back light source 11 enters into the liquid crystal lens array 13 after passing through the liquid crystal display panel 12.

When the naked eye three-dimensional liquid crystal display panel 10 is in a three-dimensional display mode, each of the lens units in the liquid crystal lens array 13 has a converging effect enabling an emitted light of a setting region on the naked eye three-dimensional liquid crystal display panel 10 to converge on a left eye or a right eye of a human, and a three-dimensional naked eye screen display of the naked eye three-dimensional liquid crystal display panel 10 is achieved accordingly. When the naked eye three-dimensional liquid crystal display panel 10 is in a two-dimensional display mode, each of the lens units in the liquid crystal lens array 13 only has a transmitting effect, and a normal two-dimensional screen display can be performed on the naked eye three-dimensional liquid crystal display panel 10.

However, the transparent blanket 136 would influence a transmitting light path of an emitted light if the emitted light of the liquid crystal display panel 12 passes through the transparent blanket 136, due to the lens liquid crystal layer 133 of the lens units being isolated by the transparent blanket 136. Therefore, a light passing through the transparent blanket 136 cannot converge with other corresponding lights without passing through the transparent blanket 136. This makes the light which passes through the transparent blanket 136 become a stray light under the three-dimensional display mode, such that the three-dimensional display effect of the naked eye three-dimensional liquid crystal display panel 10 is affected, and a three-dimensional crosstalk phenomenon easily appears. For example, a converging point of a light “a” and a light “b” should be a point “o” in FIG. 1, but the light “a” and the light “b” become stray lights inducing the crosstalk phenomenon due to an influence of the transparent blanket 136.

### SUMMARY OF THE DISCLOSURE

An object is used to provide a naked eye three-dimensional liquid crystal display panel and a naked eye three-dimensional liquid crystal display device, which can effectively eliminate a stray light and avoid a three-dimensional crosstalk phenomenon, so as to solve a technical problem that a three-dimensional crosstalk phenomenon easily appears in a conventional naked eye three-dimensional liquid crystal display panel and a naked eye three-dimensional liquid crystal display device.

An embodiment of the present disclosure provides a naked eye three-dimensional liquid crystal display panel, comprising: a back light source, a liquid crystal display panel, and a liquid crystal lens array, wherein the back light source is disposed on a side of a light incidence surface of the liquid crystal display panel, and the liquid crystal lens array is disposed on a side of a light emitting surface of the liquid crystal display panel;

wherein the liquid crystal display panel comprises a color filter substrate, an array substrate, and a display liquid crystal layer disposed between the color filter substrate and the array substrate, and the liquid crystal display panel comprises a plurality of pixel units;

wherein the liquid crystal lens array comprises a first substrate, a second substrate, and a lens liquid crystal layer disposed between the first substrate and the second substrate, and the liquid crystal lens array comprises a plurality of lens units;

wherein a black blanket structure is disposed in the lens liquid crystal layer and between the neighboring lens units;

wherein the lens units are corresponding to at least one of the pixel units; and

wherein a transparent common electrode is disposed on the first substrate of the lens unit, a lens control electrode is disposed on the second substrate of the lens unit, and a voltage is applied between the transparent common electrode and the lens control electrode to control an operating mode of each of the lens units.

An embodiment of the present disclosure further provides a naked eye three-dimensional liquid crystal display panel, comprising: a back light source, a liquid crystal display panel, and a liquid crystal lens array, wherein the back light source is disposed on a side of a light incidence surface of the liquid crystal display panel, and the liquid crystal lens array is disposed on a side of a light emitting surface of the liquid crystal display panel;

wherein the liquid crystal display panel comprises a color filter substrate, an array substrate and a display liquid crystal layer disposed between the color filter substrate and the array substrate, and the liquid crystal display panel comprises a plurality of pixel units;

wherein the liquid crystal lens array comprises a first substrate, a second substrate and a lens liquid crystal layer disposed between the first substrate and the second substrate, and the liquid crystal lens array comprises a plurality of lens units; and

wherein a black blanket structure is disposed in the lens liquid crystal layer and between the neighboring lens units.

In the naked eye three-dimensional liquid crystal display panel of the present disclosure, the black blanket structure is a black blanket formed by a black photoresist material.

In the naked eye three-dimensional liquid crystal display panel of the present disclosure, the black blanket structure comprises a transparent blanket formed by a transparent photoresist material and black matrices disposed on two ends of the transparent blanket.

In the naked eye three-dimensional liquid crystal display panel of the present disclosure, the lens units are corresponding to at least one of the pixel units.

In the naked eye three-dimensional liquid crystal display panel of the present disclosure, the lens units are one-to-one corresponding to the pixel units.

In the naked eye three-dimensional liquid crystal display panel of the present disclosure, a transparent common electrode is disposed on the first substrate of the lens unit, a lens control electrode is disposed on the second substrate of the lens unit, and a voltage is applied between the transparent common electrode and the lens control electrode to control an operating mode of each of the lens units.

In the naked eye three-dimensional liquid crystal display panel of the present disclosure, when the voltage is applied between the transparent common electrode and the lens control electrode, the corresponding lens units are in a convex lens operating mode, such that a naked eye three-dimensional screen display is performed on the naked eye three-dimensional liquid crystal display panel; and when the voltage is not applied between the transparent common electrode and the lens control electrode, the corresponding lens units are in a lens operating mode, such that a two-dimensional screen display is performed on the naked eye three-dimensional liquid crystal display panel.

In the naked eye three-dimensional liquid crystal display panel of the present disclosure, the identical transparent common electrode is used by the lens units together.

In the naked eye three-dimensional liquid crystal display panel of the present disclosure, the liquid crystal lens array is disposed on the side of the light emitting surface of the liquid crystal display panel by a transparent glue.

An embodiment of the present disclosure further provides a naked eye three-dimensional liquid crystal display device, comprising a naked eye three-dimensional liquid crystal display panel, the naked eye three-dimensional liquid crystal display panel comprising: a back light source, a liquid crystal display panel, and a liquid crystal lens array, wherein the back light source is disposed on a side of a light incidence surface of the liquid crystal display panel, and the liquid crystal lens array is disposed on a side of a light emitting surface of the liquid crystal display panel;

wherein the liquid crystal display panel comprises a color filter substrate, an array substrate and a display liquid crystal layer disposed between the color filter substrate and the array substrate, and the liquid crystal display panel comprises a plurality of pixel units;

wherein the liquid crystal lens array comprises a first substrate, a second substrate and a lens liquid crystal layer disposed between the first substrate and the second substrate, and the liquid crystal lens array comprises a plurality of lens units; and

wherein a black blanket structure is disposed in the lens liquid crystal layer and between the neighboring lens units.

In the naked eye three-dimensional liquid crystal display device of the present disclosure, the black blanket structure is a black blanket formed by a black photoresist material.

In the naked eye three-dimensional liquid crystal display device of the present disclosure, the black blanket structure comprises a transparent blanket formed by a transparent photoresist material and black matrices disposed on two ends of the transparent blanket.

In the naked eye three-dimensional liquid crystal display device of the present disclosure, the lens units are corresponding to at least one of the pixel units.

In the naked eye three-dimensional liquid crystal display device of the present disclosure, the lens units are one-to-one corresponding to the pixel units.

In the naked eye three-dimensional liquid crystal display device of the present disclosure, a transparent common electrode is disposed on the first substrate of the lens unit, a lens control electrode is disposed on the second substrate of the lens unit, and a voltage is applied between the transparent common electrode and the lens control electrode to control an operating mode of each of the lens units.

In the naked eye three-dimensional liquid crystal display device of the present disclosure, when the voltage is applied between the transparent common electrode and the lens control electrode, the corresponding lens units are in a convex lens operating mode, such that a naked eye three-dimensional screen display is performed on the naked eye three-dimensional liquid crystal display panel; and when the voltage is not applied between the transparent common electrode and the lens control electrode, the corresponding lens units are in a lens operating mode, such that a two-dimensional screen display is performed on the naked eye three-dimensional liquid crystal display panel.

In the naked eye three-dimensional liquid crystal display device of the present disclosure, the identical transparent common electrode is used by the lens units together.

In the naked eye three-dimensional liquid crystal display device of the present disclosure, the liquid crystal lens array is disposed on the side of the light emitting surface of the liquid crystal display panel by a transparent glue.

A naked eye three-dimensional liquid crystal display panel and a naked eye three-dimensional liquid crystal display device of the present disclosure can effectively avoid an influence of a transparent blanket on a transmitting light path of an emitted light by disposing a black blanket structure in the lens liquid crystal layer and between the neighboring lens units, so as to enable eliminating a stray light and avoiding an appearance of a three-dimensional crosstalk phenomenon. A technical problem, that a three-dimensional crosstalk phenomenon easily appears in a conventional naked eye three-dimensional liquid crystal display panel and a naked eye three-dimensional liquid crystal display device, is solved.

### DESCRIPTION OF THE DRAWINGS

In order to more clearly describe embodiments of the present disclosure or technical solutions in a conventional technology, drawings required to be used for the embodiments or descriptions of the conventional technology are simply described hereinafter. Apparently, the drawings described below only illustrate some embodiments of the present disclosure. Those skilled in the art can obtain other drawings based on these drawings disclosed herein without creative effort, wherein:

FIG. 1 is a structural schematic diagram of a conventional naked eye three-dimensional liquid crystal display panel.

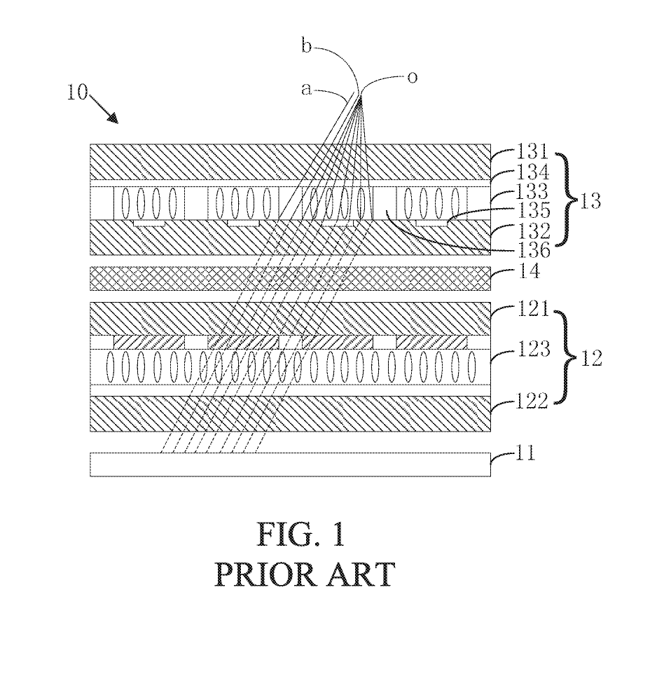

FIG. 2 is a structural schematic diagram of a first preferred embodiment of a naked eye three-dimensional liquid crystal display panel of the present disclosure.

FIG. 3 is a structural schematic diagram of a second preferred embodiment of a naked eye three-dimensional liquid crystal display panel of the present disclosure.

### DETAILED DESCRIPTION OF THE PREFERRED EMBODIMENTS

The technical solutions in the embodiments of the present disclosure will be described in the following with reference to the accompanying drawings in the embodiments of the present disclosure in a clear and complete manner. Apparently, the described embodiments are merely part of the present disclosure, and are not all embodiments. All other embodiments obtained by those of ordinary skill in the art without making creative work are within the scope of the present disclosure, based on the embodiments in the present disclosure.

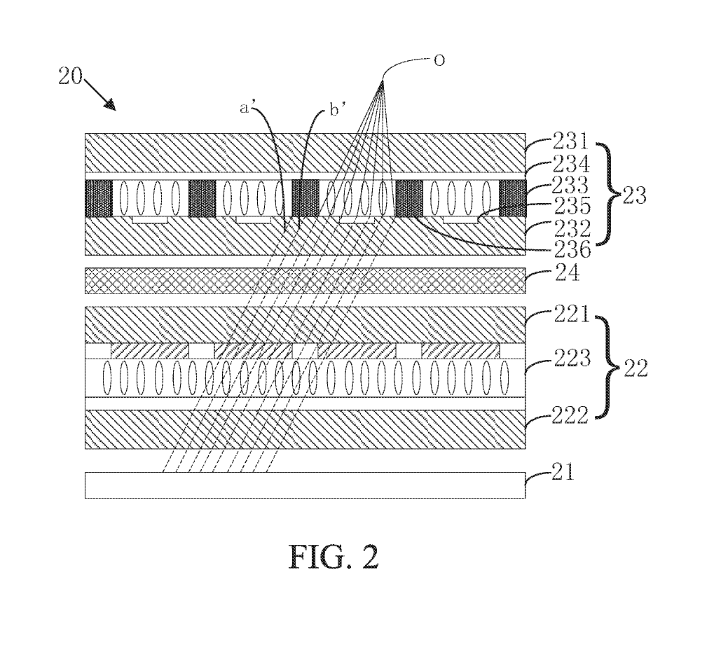

Please refer to FIG. 2. FIG. 2 is a structural schematic diagram of a first preferred embodiment of a naked eye three-dimensional liquid crystal display panel of the present disclosure. The naked eye three-dimensional liquid crystal display panel 20 of the present preferred embodiment comprises a back light source 21, a liquid crystal display panel 22, and a liquid crystal lens array 23, wherein the back light source 21 is disposed on a side of a light incidence surface of the liquid crystal display panel 22, and the liquid crystal lens array 23 is disposed on a side of a light emitting surface of the liquid crystal display panel 22 by a transparent glue 24.

The liquid crystal display panel 22 comprises a color filter substrate 221, an array substrate 222, and a display liquid crystal layer 223 disposed between the color filter substrate 221 and the array substrate 222, wherein a pixel electrode is disposed on the array substrate 222, and a common electrode and color resists are disposed on the color filter substrate 221, such as a red resist, a green resist, a blue resist, etc. Therefore, the liquid crystal display panel 22 can form a plurality of pixel units by disposing the pixel electrode, the common electrode, and the color resists. Each of the pixel units can be separately driven to display a pixel screen.

The liquid crystal lens array 23 comprises a first substrate 231, a second substrate 232, and a lens liquid crystal layer 233 disposed between the first substrate 231 and the second substrate 232, wherein a transparent common electrode 234 is disposed on the first substrate 231, and a transparent control electrode 235 is disposed on the second substrate 232. Therefore, the liquid crystal lens array 23 can form a plurality of lens units by disposing the transparent control electrode 235. These lens units can use the identical common electrode 234 together, thereby simplifying a control process of the transparent control electrode 235.

Transparent units can be corresponding to at least one of the pixel units, or the lens units are one-to-one corresponding to the pixel units. Here, the pixel units corresponding to the transparent units can be disposed according to a user's requirement.

A black matrix structure is disposed in the lens liquid crystal layer 233 and between the neighboring lens units. In the present preferred embodiment, the black blanket structure is a black blanket 236 formed by a black photoresist material.

The naked eye three-dimensional liquid crystal display panel 20 of the present preferred embodiment has a naked eye three-dimensional screen display mode and a two-dimensional screen display mode. When the naked eye three-dimensional liquid crystal display panel 20 of the present preferred embodiment is in a naked eye three-dimensional screen display mode, a voltage is applied between the transparent common electrode 234 of the lens unit and the lens control electrode 235, the lens liquid crystal layer 233 in the corresponding lens unit forms a convex lens used for performing a converging operation on an incident light, which means the corresponding lens unit is in a convex lens operating mode. Therefore, an emitted light corresponding to each of the pixel units of the liquid crystal display panel 22 converges to a left eye or a right eye of a viewer, which means that the naked eye three-dimensional screen display of the naked eye three-dimensional liquid crystal display panel 20 is achieved.

The emitted light of the neighboring lens units cannot emit externally from the current lens units through the black blanket 236, since a black blanket structure is disposed in the lens liquid crystal layer 233 and between the neighboring lens units. Therefore, stray lights in the current lens units are effectively avoided, such as a′ and b′ in FIG. 2, thereby effectively avoiding an appearance of a three-dimensional crosstalk phenomenon.

When the naked eye three-dimensional liquid crystal display panel 20 of the present preferred embodiment is in a two-dimensional screen display mode, a voltage is applied between the transparent common electrode 234 of the lens unit and the lens control electrode 235, and the lens liquid crystal layer 233 in the lens unit would not perform any operation on the incident light, which means the corresponding lens unit is in a lens operating mode. Therefore, each of the pixel units of the liquid crystal display panel 22 would normally display, and the two-dimensional screen display of the naked eye three-dimensional liquid crystal display panel 20 is achieved.

From the above, the naked eye three-dimensional screen display process and the two-dimensional screen display process of the naked eye three-dimensional liquid crystal display panel 20 of the present preferred embodiment is completed.

A naked eye three-dimensional liquid crystal display panel of the present preferred embodiment can effectively avoid an influence of a transparent blanket on a transmitting light path of an emitted light by disposing a black blanket structure in the lens liquid crystal layer and between the neighboring lens units, so as to enable eliminating a stray light and avoiding an appearance of a three-dimensional crosstalk phenomenon.

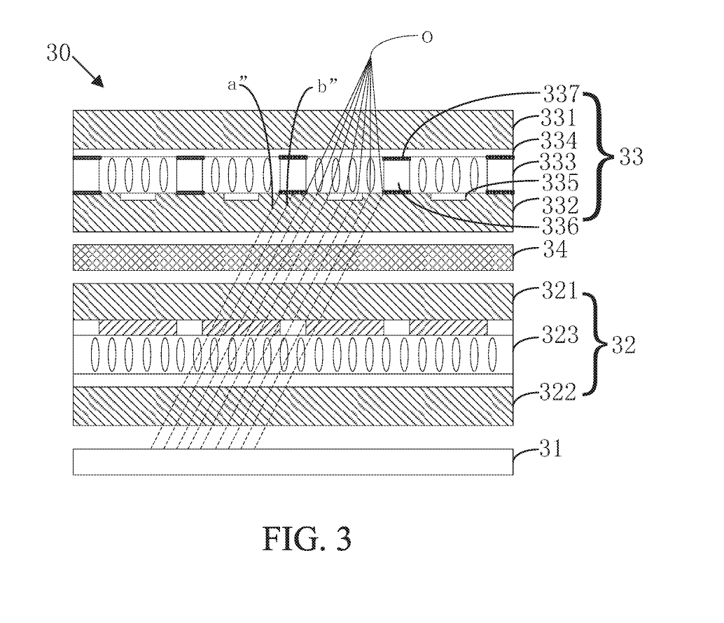

Please refer to FIG. 3. FIG. 3 is a structural schematic diagram of a second preferred embodiment of a naked eye three-dimensional liquid crystal display panel of the present disclosure. The naked eye three-dimensional liquid crystal display panel 30 of the present preferred embodiment comprises a back light source 31, a liquid crystal display panel 32, and a liquid crystal lens array 33, wherein the back light source 31 is disposed on a side of a light incidence surface of the liquid crystal display panel 32, and the liquid crystal lens array 33 is disposed on a side of a light emitting surface of the liquid crystal display panel 32 by a transparent glue 34.

The liquid crystal display panel 32 comprises a color filter substrate 321, an array substrate 322, and a display liquid crystal layer 323 disposed between the color filter substrate 321 and the array substrate 322, wherein a pixel electrode is disposed on the array substrate 322, and a common electrode and color resists are disposed on the color filter substrate 321. Therefore, the liquid crystal display panel 32 can form a plurality of pixel units by disposing the pixel electrode, the common electrode and the color resists. Each of the pixel units can be separately driven to display a pixel screen.

The liquid crystal lens array 33 comprises a first substrate 331, a second substrate 332 and a lens liquid crystal layer 333 disposed between the first substrate 331 and the second substrate 332, wherein a transparent common electrode 334 is disposed on the first substrate 331, and a transparent control electrode 335 is disposed on the second substrate 332. Therefore, the liquid crystal lens array 33 can form a plurality of lens units by disposing the transparent control electrode 335. These lens units can use the identical common electrode 334 together, thereby simplifying a control process of the transparent control electrode 335.

Transparent units can be corresponding to at least one of the pixel units, or the lens units are one-to-one corresponding to the pixel units. Here, the pixel units corresponding to the transparent units can be disposed according to a user's requirement.

A black matrix structure is disposed in the lens liquid crystal layer 333 and between the neighboring lens units. In the present preferred embodiment, the black blanket structure comprises a transparent blanket 336 formed by a transparent photoresist material and black matrices 337 disposed on two ends of the transparent blanket 336.

The naked eye three-dimensional liquid crystal display panel 30 of the present preferred embodiment has a naked eye three-dimensional screen display mode and a two-dimensional screen display mode. When the naked eye three-dimensional liquid crystal display panel 30 of the present preferred embodiment is in a naked eye three-dimensional screen display mode, a voltage is applied between the transparent common electrode 334 of the lens unit and the lens control electrode 335, the lens liquid crystal layer 333 in the corresponding lens unit forms a convex lens used for performing a converging operation on an incident light, which means the corresponding lens unit is in a convex lens operating mode. Therefore, an emitted light corresponding to each of the pixel units of the liquid crystal display panel 32 converges to a left eye or a right eye of a viewer, which means that the naked eye three-dimensional screen display of the naked eye three-dimensional liquid crystal display panel 30 is achieved.

Although the emitted light of the neighboring lens units can transmit to the current lens units through the transparent blanket 336 of the black blanket structure, the black matrices 337 disposed on the two ends of the transparent blanket 336 would adsorb the emitted light which transmits to the current lens units. Therefore, stray lights in the current lens units are effectively avoided, such as a″ and b″ in FIG. 3, thereby effectively avoiding an appearance of a three-dimensional crosstalk phenomenon.

When the naked eye three-dimensional liquid crystal display panel 30 of the present preferred embodiment is in a two-dimensional screen display mode, a voltage is applied between the transparent common electrode 334 of the lens unit and the lens control electrode 335, and the lens liquid crystal layer 333 in the lens unit does not perform any operation on the incident light, which means the corresponding lens unit is in a lens operating mode. Therefore, each of the pixel units of the liquid crystal display panel 32 would normally display, and the two-dimensional screen display of the naked eye three-dimensional liquid crystal display panel 30 is achieved.

From the above, the naked eye three-dimensional screen display process and the two-dimensional screen display process of the naked eye three-dimensional liquid crystal display panel 30 of the present preferred embodiment is completed.

A naked eye three-dimensional liquid crystal display panel of the present preferred embodiment can effectively avoid an influence of a transparent blanket on a transmitting light path of an emitted light by disposing a transparent blanket, which has black matrices on two ends of the transparent blanket, in the lens liquid crystal layer and between the neighboring lens units, so as to enable eliminating a stray light and avoiding an appearance of a three-dimensional crosstalk phenomenon.

The present disclosure further provides a naked eye three-dimensional liquid crystal display device, comprising a naked eye three-dimensional liquid crystal display panel, the naked eye three-dimensional liquid crystal display panel comprising: a back light source, a liquid crystal display panel and a liquid crystal lens array, wherein the back light source is disposed on a side of a light incidence surface of the liquid crystal display panel, and the liquid crystal lens array is disposed on a side of a light emitting surface of the liquid crystal display panel.

The liquid crystal display panel comprises a color filter substrate, an array substrate and a display liquid crystal layer disposed between the color filter substrate and the array substrate, and the liquid crystal display panel comprises a plurality of pixel units. The liquid crystal lens array comprises a first substrate, a second substrate, and a lens liquid crystal layer disposed between the first substrate and the second substrate, and the liquid crystal lens array comprises a plurality of lens units. A black blanket structure is disposed in the lens liquid crystal layer and between the neighboring lens units.

Preferably, the black blanket structure is a black blanket formed by a black photoresist material.

Preferably, the black blanket structure comprises a transparent blanket formed by a transparent photoresist material and black matrices disposed on two ends of the transparent blanket.

Preferably, the lens units are corresponding to at least one of the pixel units.

Preferably, the lens units are one-to-one corresponding to the pixel units.

Preferably, a transparent common electrode is disposed on the first substrate of the lens unit, a lens control electrode is disposed on the second substrate of the lens unit, and a voltage is applied between the transparent common electrode and the lens control electrode to control an operating mode of each of the lens units.

Preferably, when the voltage is applied between the transparent common electrode and the lens control electrode, the corresponding lens units are in a convex lens operating mode, such that a naked eye three-dimensional screen display is performed on the naked eye three-dimensional liquid crystal display panel; and when the voltage is not applied between the transparent common electrode and the lens control electrode, the corresponding lens units are in a lens operating mode, such that a two-dimensional screen display is performed on the naked eye three-dimensional liquid crystal display panel.

Preferably, the identical transparent common electrode is used by the lens units together.

Preferably, the liquid crystal lens array is disposed on the side of the light emitting surface of the liquid crystal display panel by a transparent glue.

A naked eye three-dimensional liquid crystal display panel and a naked eye three-dimensional liquid crystal display device of the present disclosure can effectively avoid an influence of a transparent blanket on a transmitting light path of an emitted light by disposing a black blanket structure in the lens liquid crystal layer and between the neighboring lens units, so as to enable eliminating a stray light and avoiding an appearance of a three-dimensional crosstalk phenomenon. A technical problem, that a three-dimensional crosstalk phenomenon easily appear in a conventional naked eye three-dimensional liquid crystal display panel and a naked eye three-dimensional liquid crystal display device, is solved.

As described above, although the present disclosure has been described in preferred embodiments, they are not intended to limit the disclosure. One of ordinary skill in the art, without departing from the spirit and scope of the disclosure within, can make various modifications and variations, so the range of the scope of the disclosure is defined by the claims.

What is claimed is:

1. A naked eye three-dimensional liquid crystal display panel, comprising: a back light source, a liquid crystal display panel, and a liquid crystal lens array, wherein the back light source is disposed on a side of a light incidence surface of the liquid crystal display panel, and the liquid crystal lens array is disposed on a side of a light emitting surface of the liquid crystal display panel;
wherein the liquid crystal display panel comprises a color filter substrate, an array substrate, and a display liquid crystal layer disposed between the color filter substrate and the array substrate, and the liquid crystal display panel comprises a plurality of pixel units;
wherein the liquid crystal lens array comprises a first substrate, a second substrate, and a lens liquid crystal layer disposed between the first substrate and the second substrate, and the liquid crystal lens array comprises a plurality of lens units;
wherein a black blanket structure is disposed in the lens liquid crystal layer and between the neighboring lens units;
wherein the lens units are corresponding to at least one of the pixel units; and
wherein a transparent common electrode is disposed on the first substrate of the lens unit, a lens control electrode is disposed on the second substrate of the lens unit, and a voltage is applied between the transparent common electrode and the lens control electrode to control an operating mode of each of the lens units.

2. A naked eye three-dimensional liquid crystal display panel, comprising: a back light source, a liquid crystal display panel, and a liquid crystal lens array, wherein the back light source is disposed on a side of a light incidence surface of the liquid crystal display panel, and the liquid crystal lens array is disposed on a side of a light emitting surface of the liquid crystal display panel;
wherein the liquid crystal display panel comprises a color filter substrate, an array substrate and a display liquid crystal layer disposed between the color filter substrate and the array substrate, and the liquid crystal display panel comprises a plurality of pixel units;
wherein the liquid crystal lens array comprises a first substrate, a second substrate, and a lens liquid crystal layer disposed between the first substrate and the second substrate, and the liquid crystal lens array comprises a plurality of lens units; and
wherein a black blanket structure is disposed in the lens liquid crystal layer and between the neighboring lens units.

3. The naked eye three-dimensional liquid crystal display panel according to claim 2, wherein the black blanket structure is a black blanket formed by a black photoresist material.

4. The naked eye three-dimensional liquid crystal display panel according to claim 2, wherein the black blanket structure comprises a transparent blanket formed by a transparent photoresist material and black matrices disposed on two ends of the transparent blanket.

5. The naked eye three-dimensional liquid crystal display panel according to claim 2, wherein the lens units are corresponding to at least one of the pixel units.

6. The naked eye three-dimensional liquid crystal display panel according to claim 5, wherein the lens units are one-to-one corresponding to the pixel units.

7. The naked eye three-dimensional liquid crystal display panel according to claim 2, wherein a transparent common electrode is disposed on the first substrate of the lens unit, a lens control electrode is disposed on the second substrate of the lens unit, and a voltage is applied between the transparent common electrode and the lens control electrode to control an operating mode of each of the lens units.

8. The naked eye three-dimensional liquid crystal display panel according to claim 7, wherein:
when the voltage is applied between the transparent common electrode and the lens control electrode, the corresponding lens units are in a convex lens operating mode, such that a naked eye three-dimensional screen display is performed on the naked eye three-dimensional liquid crystal display panel; and
when the voltage is not applied between the transparent common electrode and the lens control electrode, the corresponding lens units are in a lens operating mode, such that a naked eye two-dimensional display is performed on the naked eye three-dimensional liquid crystal display panel.

9. The naked eye three-dimensional liquid crystal display panel according to claim 7, wherein the identical transparent common electrode is used by the lens units together.

10. The naked eye three-dimensional liquid crystal display panel according to claim 2, wherein the liquid crystal lens array is disposed on the side of the light emitting surface of the liquid crystal display panel by a transparent glue.

11. A naked eye three-dimensional liquid crystal display device, comprising a naked eye three-dimensional liquid crystal display panel, the naked eye three-dimensional liquid crystal display panel comprising: a back light source, a liquid crystal display panel and a liquid crystal lens array, wherein the back light source is disposed on a side of a light incidence surface of the liquid crystal display panel, and the liquid crystal lens array is disposed on a side of a light emitting surface of the liquid crystal display panel;
wherein the liquid crystal display panel comprises a color filter substrate, an array substrate, and a display liquid crystal layer disposed between the color filter substrate and the array substrate, and the liquid crystal display panel comprises a plurality of pixel units;
wherein the liquid crystal lens array comprises a first substrate, a second substrate, and a lens liquid crystal layer disposed between the first substrate and the second substrate, and the liquid crystal lens array comprises a plurality of lens units; and
wherein a black blanket structure is disposed in the lens liquid crystal layer and between the neighboring lens units.

12. The naked eye three-dimensional liquid crystal display device according to claim 11, wherein the black blanket structure is a black blanket formed by a black photoresist material.

13. The naked eye three-dimensional liquid crystal display device according to claim 11, wherein the black blanket structure comprises a transparent blanket formed by a transparent photoresist material and black matrices disposed on two ends of the transparent blanket.

14. The naked eye three-dimensional liquid crystal display device according to claim 11, wherein the lens units are corresponding to at least one of the pixel units.

15. The naked eye three-dimensional liquid crystal display device according to claim 14, wherein the lens units are one-to-one corresponding to the pixel units.

16. The naked eye three-dimensional liquid crystal display device according to claim 11, wherein a transparent common electrode is disposed on the first substrate of the lens unit, a lens control electrode is disposed on the second substrate of the lens unit, and a voltage is applied between the transparent common electrode and the lens control electrode to control an operating mode of each of the lens units.

17. The naked eye three-dimensional liquid crystal display device according to claim 16, wherein:
when the voltage is applied between the transparent common electrode and the lens control electrode, the corresponding lens units are in a convex lens operating mode, such that a naked eye three-dimensional screen display is performed on the naked eye three-dimensional liquid crystal display panel; and
when the voltage is not applied between the transparent common electrode and the lens control electrode, the corresponding lens units are in a lens operating mode, such that a naked eye two-dimensional display is performed on the naked eye three-dimensional liquid crystal display panel.

18. The naked eye three-dimensional liquid crystal display device according to claim 16, wherein the identical transparent common electrode is used by the lens units together.

19. The naked eye three-dimensional liquid crystal display device according to claim 11, wherein the liquid crystal lens array is disposed on the side of the light emitting surface of the liquid crystal display panel by a transparent glue.
